(19) United States
(12) Patent Application Publication
(10) Pub. No.: US 2013/0070368 A1
(43) Pub. Date: Mar. 21, 2013

(54) MAGNETIC DISK DEVICE AND CONTROLLING METHOD OF HEAD

(71) Applicants: Shinji Takakura, Kanagawa-ken (JP); Shigen Yasunaka, Kanagawa-ken (JP); Yoshiyuki Ishihara, Kanagawa-ken (JP)

(72) Inventors: Shinji Takakura, Kanagawa-ken (JP); Shigen Yasunaka, Kanagawa-ken (JP); Yoshiyuki Ishihara, Kanagawa-ken (JP)

(73) Assignee: KABUSHIKI KAISHA TOSHIBA, Tokyo (JP)

(21) Appl. No.: 13/424,576

(22) Filed: Mar. 20, 2012

(30) Foreign Application Priority Data
Sep. 20, 2011 (JP) 2011-205393

(51) Int. Cl. G11B 21/02

(52) U.S. Cl. 360/75; G9B/21.003

(57) ABSTRACT

A magnetic disk device includes a head, a coil, a drive circuit, a detector, a first calculation unit, a generation unit, a first estimation unit, and a control unit. The detector detects an inter-terminal voltage across the coil. The first calculation unit calculates a back electromotive force across the coil by the use of the inter-terminal voltage. The generation unit generates a target velocity as a reference value of a velocity of the head. The first estimation unit estimates a first velocity of the head and an error of the first velocity by the use of the back electromotive force. The first estimation unit estimates a second velocity for decreasing the error. The control unit calculates a control instruction to bring the second velocity close to the target velocity.

### CROSS REFERENCE TO RELATED APPLICATION

This application is based upon and claims the benefit of priority from the prior Japanese Patent Application No. 2011-205393, filed on Sep. 20, 2011, the entire contents of which are incorporated herein by reference.

### FIELD

Embodiments basically relate to a magnetic disk device and a head control method.

### BACKGROUND

A head position error signal is used to control a position and a velocity of a head of a magnetic disk device. The head position error signal is obtained by reproducing servo information included in servo sectors on the surface of the magnetic disk. However, it is impossible to obtain the head position error signal after the head enters into a ramp mechanism during unload operation.

During the unload operation, the velocity of the head is estimated using a back electromotive force so that the velocity of the head can be controlled even within the ramp mechanism. The back electromotive force is generated by a voice control motor.

### BRIEF DESCRIPTION OF THE DRAWINGS

Aspects of this disclosure will become apparent upon reading the following detailed description and upon reference to the accompanying drawings.

FIG. 1 is a schematic configuration diagram showing a magnetic disk device in accordance with a first embodiment.

FIG. 2 is an equivalent circuit diagram showing a voice coil motor of the magnetic disk device in accordance with the first embodiment.

FIG. 3 is a system configuration diagram showing an MPU of the magnetic disk device in accordance with the first embodiment.

FIG. 4 is a diagram showing an example of a target velocity.

FIG. 5 is a block diagram to describe an operation of the MPU of the magnetic disk device in accordance with the first embodiment.

FIG. 6 is a diagram showing an example of a function f(d).

FIGS. 7A and 7B are diagrams showing time histories of outputs of a microphone during an unload operation in the embodiment and the background art, respectively.

FIG. 8 is a block diagram to describe an MPU of a magnetic disk device in accordance with a modification of the first embodiment.

FIGS. 9A and 9B are diagrams showing time histories of a velocity of a head during the unload operation in the embodiment and the background art, respectively.

### DESCRIPTION

As will be described below, in accordance with an embodiment, a magnetic disk device includes a head, a coil, a drive circuit, a detector, a first calculation unit, a generation unit, a first estimation unit, and a control unit. The head write in and read out information onto and from an information storage medium. The coil motor has a coil with terminals at both ends to move the head. The drive circuit drives the coil motor. The detector detects an inter-terminal voltage across the coil. The first calculation unit calculates a back electromotive force across the coil by the use of the inter-terminal voltage. The generation unit generates a target velocity as a reference value of a velocity of the head. The first estimation unit estimates a first velocity of the head and an error of the first velocity for each sampling time by the use of the back electromotive force. The first estimation unit estimates a second velocity for a succeeding sampling time immediately after the sampling time for decreasing the error. The control unit calculates a control instruction to bring the second velocity close to the target velocity.

In accordance with another embodiment, a controlling method of a head included in a magnetic disk device is described. The device includes a head, a coil, a drive circuit, a detector, a first calculation unit, a generation unit, a first estimation unit, and a control unit. The head write in and read out information onto and from an information storage medium. The coil motor has a coil with terminals at both ends to move the head. The drive circuit drives the coil motor. The detector detects an inter-terminal voltage across the coil. The first calculation unit calculates a back electromotive force across the coil by the use of the inter-terminal voltage. The generation unit generates a target velocity as a reference value of a velocity of the head. The first estimation unit estimates a first velocity of the head and an error of the first velocity by the use of the back electromotive force. The first estimation unit estimates a second velocity for decreasing the error. The control unit calculates a control instruction to bring the second velocity close to the target velocity.

The method includes the following steps:

detecting the inter-terminal voltage across the coil;

calculating the back electromotive force across the coil, the first calculation unit using the inter-terminal voltage to calculate the back electromotive force;

generating the target velocity, the generation unit generating the target velocity, the target velocity serving as the reference value of the moving velocity of the head;

estimating the first velocity and the error, the first estimation unit using the back electromotive force to estimate the first velocity and the error;

estimating the second velocity, the first estimation unit estimating the second velocity to reduce the error by; and

calculating the control instruction for bringing the second velocity close to the target velocity, the control unit calculating the control instruction.

Embodiments will be described below.

### First Embodiment

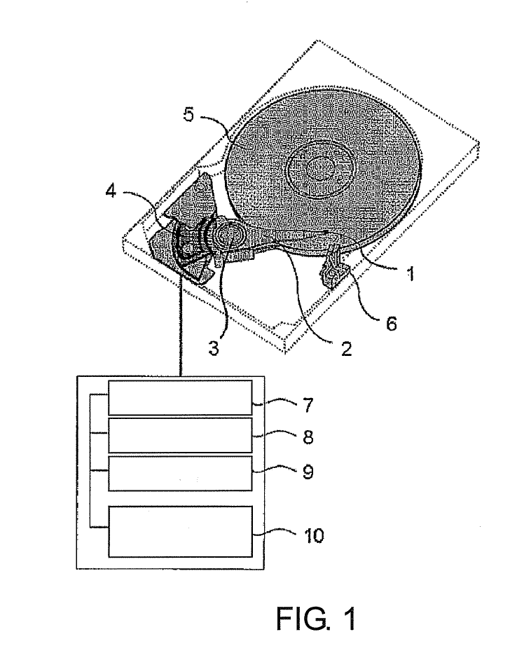

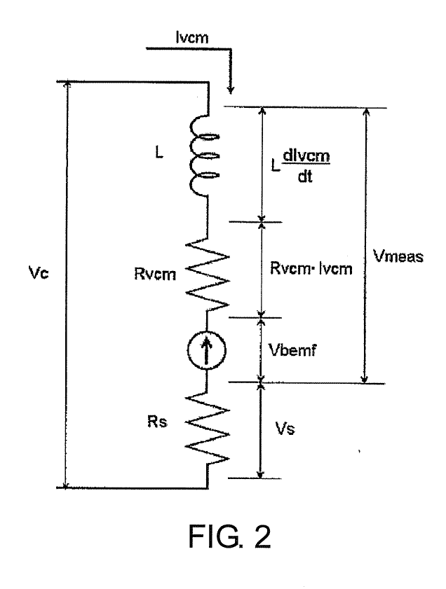

FIG. 1 is a schematic configuration diagram showing a magnetic disk device according to a first embodiment. FIG. 2 is an equivalent circuit diagram of a voice coil motor (hereinafter referred to as a “VCM”) 4 of the magnetic disk device according to the first embodiment.

The magnetic disk device of FIG. 1 includes a head 1 to write in and read out information to and from an information storage medium 5 such as a magnetic disk having a plurality of servo sectors, an arm 2 to support the head 1, the VCM 4 to move the head 1, a VCM drive circuit 7 to drive the VCM 4, a detector 8 to detect a coil inter-terminal voltage in the VCM 4, a memory 9, and an MPU 10 to perform velocity control during unload operation.

The head 1 is supported at an end of the arm 2. When the VCM 4 rotates the arm 2 around a rotation axis 3, the head 1 moves in a radius direction above a surface of the magnetic disk 5 rotated by a spindle motor (not shown), thereby performing seek operation and follow operation.

The head 1 can write in and read out information to and from the magnetic disk 5 at any given location. In the normal seek operation and follow operation, the MPU 10 uses a position error signal obtained from the servo information to perform the positioning control of the head 1.

When a shock detection sensor (not shown) detects a shock applied to the magnetic disk device, or when a user turns off the device, for example, the MPU 10 switches the control system from the above-described positioning control to the velocity control, thereby performing unload operation in which the head 1 is retracted to a ramp mechanism 6.

When a recovery to load operation from the unload-state is instructed, or when a user turns on the device, the MPU 10 performs the velocity control of the head 1 in place of the positioning control for the seek operation and the follow operation to move the head 1 from the ramp mechanism 6 to above the magnetic disk 5.

The VCM 4 is a coil motor provided with a magnet and a coil which are arranged to face each other, for example. The magnet is fixed to a base. The coil is provided to the axially-supported arm 2. When a current is passed through the coil, the VCM serves as an actuator which applies rotational force to the arm 2, i.e., drives the arm 2.

The VCM 4 can be shown using the equivalent circuit diagram as shown in FIG. 2. L, R_{vcm}, and Rₛ denote an inductance, a coil resistance, and a sense resistor, respectively. V_{bemf}, I_{vcm}, Vₘₑₐₛ, and Vc denote a back electromotive force, a current passing through the coil (hereinafter referred to as a coil current), a detectable coil inter-terminal voltage, and a voltage between the coil and the sense resistor, respectively.

A VCM drive circuit 7 receives an instruction voltage from the MPU 10 in any cases of the positioning control and velocity control to pass the coil current I_{vcm} through the coil, thereby driving the arm 2.

The VCM drive circuit 7 includes a current feedback circuit. The VCM drive circuit 7 is separated from the VCM 4. In fact, the VCM drive circuit 7 and the VCM 4 are connected to each other. Accordingly, the coil of the VCM 4 may be included in a portion of the VCM drive circuit 7.

A detector 8 detects the coil inter-terminal voltage Vₘₑₐₛ. In the embodiment, the detector 8 is mentioned as a unit. Alternatively, the detector 8 may be provided as a portion of the VCM drive circuit 7.

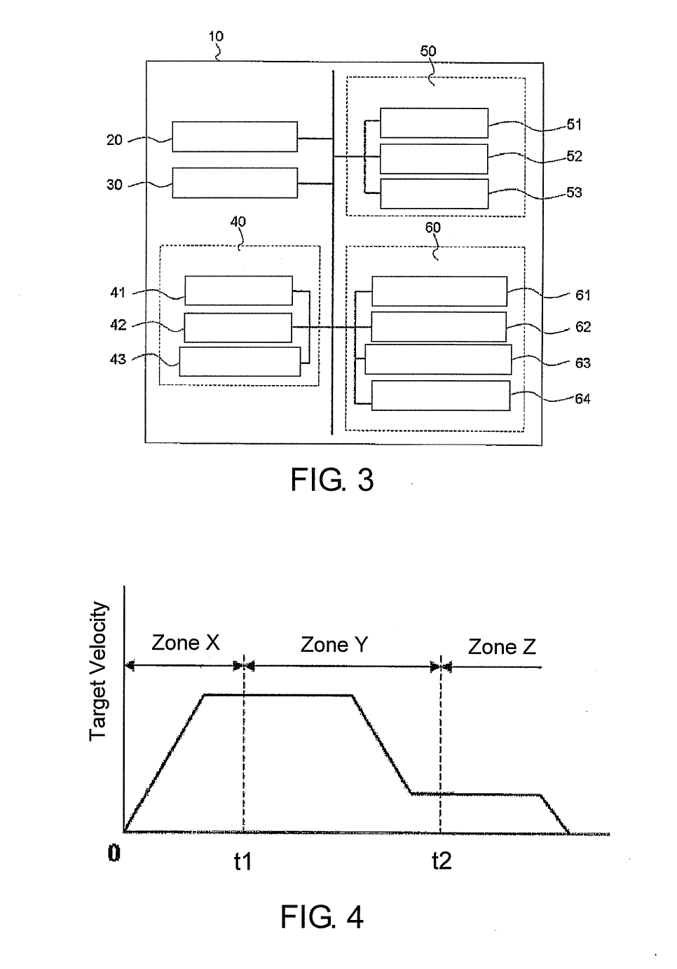

A system configuration and operation of the MPU 10 of the magnetic disk device in accordance with the embodiment will be described with reference to FIGS. 3 to 5. In the embodiment, a background art will be employed for the seek operation and the follow operation. The unload operation will be described below.

FIG. 3 is a configuration diagram of the MPU 10 of the magnetic disk device in accordance with the first embodiment.

The MPU 10 is provided with a generation unit 20 to generate a targeted velocity of the head 1 (hereinafter referred to as a target velocity), a back electromotive force calculation unit 30 to calculate the back electromotive force across the coil, a disturbance estimation unit 40 to estimate disturbance in velocity applied to the head 1, a velocity estimation unit to estimate the velocity of the head 1, and a velocity control unit to control the velocity of the head 1, as modules.

### (Whole)

The generation unit 20 generates the target velocity of the head 1 for each control cycle to input the target velocity into the velocity control unit 60 described later. The target velocity during the unload operation can be previously stored in the memory 9. FIG. 4 shows an example of the target velocity stored in the memory 9.

In FIG. 4, the head 1 starts unload operation at time 0 when the head 1 is above the surface of the magnetic disk 5. The head 1 moves to the outer circumference of the magnetic disk 5 at a fixed velocity, and runs on the ramp mechanism 6 at time t1 (Zone X). The head 1 moves toward a stopper (not shown) inside the ramp mechanism 6 to arrive at the stopper at time t2 (Zone Y). Pressed to the stopper for a while, the head 1 stands still to finish the unload operation (Zone Z).

The back electromotive force calculation unit 30 calculates the back electromotive force V_{bemf} of the coil from the coil inter-terminal voltage Vₘₑₐₛ and the coil resistance value R_{vcm} for each control cycle.

The disturbance estimation unit 40 estimates the disturbance applied to the head 1 for each control cycle to calculate a parameter Rₖ. The parameter Rₖ adjusts a control bandwidth in the velocity control described later for each control cycle. The parameter Rₖ also shows how much the disturbance included in the back electromotive force is taken into consideration on estimating the velocity of the head 1.

The velocity estimation unit 50 estimates a state variable using the back electromotive force V_{bemf} and the above-described parameter Rₖ to minimize an error of the state variable for each control cycle. Here, the state variable is expressed by a vector including the velocity of the head 1 and the disturbance applied to the head 1 as its components.

The velocity control unit 60 uses the state variable estimated by the velocity estimation unit 50 to calculate a control instruction uₖ for each control cycle, thereby bringing the velocity of the head 1 close to the target velocity thereof generated by the target value generation unit 20.

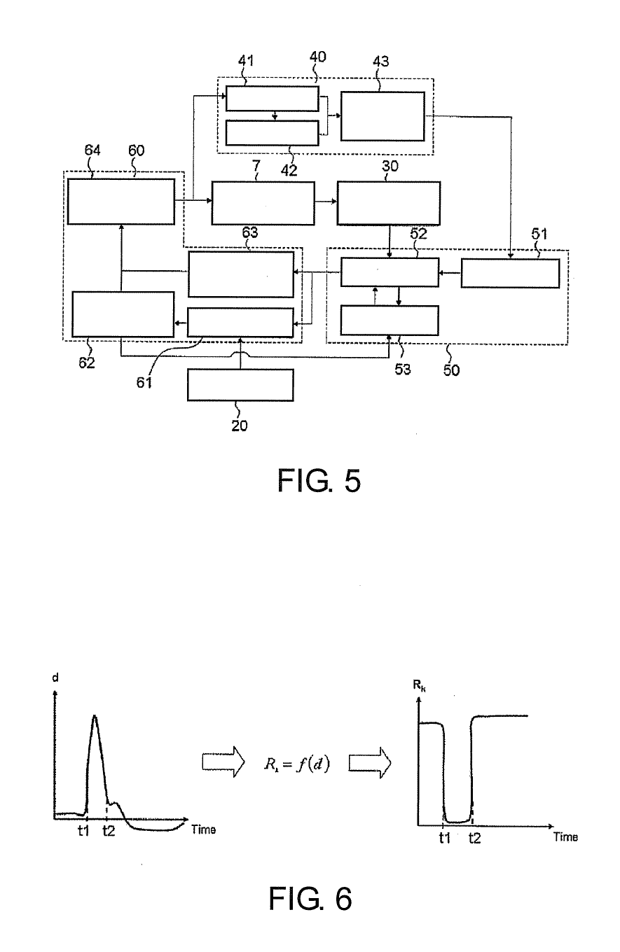

The respective modules will be described in detail with reference to the block diagram for describing an operation of the MPU 10 shown in FIG. 5.

### Back Electromotive Force Calculation Unit

The back electromotive force V_{bemf} is expressed by the following equation when the control cycle takes a time interval sufficient for attenuating the voltage caused by the inductance to remove effect of the inductance term:

V_{bemf}=Vₘₑₐₛ−R_{vcm}·I_{vcm} [Equation 1]

In the current feedback circuit, the coil current I_{vcm} is proportional to the instruction voltage V_{vcm} under the condition in which the current feedback sufficiently effects. The relationship therebetween can be expressed as I_{vcm}=βV_{vcm} using a proportionality coefficient β, thereby enabling it to transform the back electromotive force V_{bemf} into the following equation:

$$\begin{matrix}{V}_{benf} = {V}_{meas} - {R}_{vcm} \cdot β \cdot {V}_{vcm} \\ = {V}_{meas} - α \cdot {V}_{vcm} .\end{matrix} \qquad [ Equation 2 ]$$

In the above equation, “the proportionality coefficient β”×“the coil resistance R_{vcm}” is replaced by a and the value a can be regarded as a calculational coil resistance value.

In accordance with (Equation 2), the back electromotive force calculation unit 30 subtracts a multiplied value from the coil inter-terminal voltage Vₘₑₐₛ to calculate the back electromotive force V_{bemf} for each control cycle. Multiplying the coil resistance value a by the instruction voltage V_{vcm} provides the multiplied value. The coil inter-terminal voltage Vₘₑₐₛ is detected by the detector 8 to be outputted through an AD converter.

### Disturbance Estimation Unit

As shown in FIG. 3, the disturbance estimation unit 40 has an estimation unit 41, a detector 42, and a parameter calculation unit 43. The estimation unit 41 estimates the disturbance applied to the head 1. The detector 42 detects an arrival (timing of running on) of the head 1 at the ramp mechanism 6. The parameter calculation unit 43 calculates the parameter Rₖ.

The estimation unit 41 includes a disturbance observer of the background art, for example, to estimate the disturbance applied to the head 1. The estimation unit 41 uses the back electromotive force and the instruction voltage to calculate a disturbance d for each control cycle. The back electromotive force is calculated by the back electromotive force calculation unit 30.

The detector 42 uses the disturbance d calculated by the estimation unit 41 to detect the timing for the head 1 to run on the ramp mechanism 6. The detector 42 sequentially observes the disturbance d calculated for each control cycle. When the disturbance d becomes a value larger than a prescribed value to be predetermined, the detector 42 defines this time as start timing of running on by determining that the head 1 starts running on the ramp mechanism 6.

After the start timing, when the disturbance d becomes a value smaller than the prescribed, the detector 42 defines this time as end timing of running on by determining that the head 1 finishes running on the ramp mechanism 6.

The detector 42 sequentially calculates a time rate of change of the disturbance d. When this time rate of change becomes a value larger than a prescribed value to be predetermined, the detector 42 may determine that the head 1 starts running on the ramp mechanism 6. When the time rate of change becomes a value smaller than the prescribed value, the detector 42 may determine that the head 1 finishes running on the ramp mechanism 6.

The parameter calculation unit 43 obtains the start timing and the end timing from the detector 42. During the time interval from the start timing to the end timing, the parameter calculation unit 43 calculates the parameter Rₖ smaller than a parameter Rₖ for the routine operation. If the parameter Rₖ is small, a control bandwidth in the velocity control becomes high. If the parameter Rₖ is large, the control bandwidth becomes low. The routine operation excludes unload operation.

When the head 1 is running on the ramp mechanism 6, the parameter Rₖ is set small to heighten the control bandwidth in the velocity control, thereby allowing the head 1 to surely run on the ramp mechanism 6 without reducing the velocity of the head 1.

The parameter calculation unit 43 specifically passes the disturbance d calculated by the estimation unit 41 through a function f(d) to calculate the parameter Rₖ. The function f(d) has a hysteresis with respect to the change in the parameter Rₖ, for example.

FIG. 6 is a view showing an example of the function f(d). Any function f(d) may calculate the parameter Rₖ when the head 1 runs on the ramp mechanism 6 (during the time interval from the start timing to the end timing) so that the parameter Rₖ for the time interval is smaller than the parameter Rₖ for the routine operation.

### Velocity Estimation Unit

As shown in FIG. 3, the velocity estimation unit 50 has a gain updating unit 51, an estimate updating unit 52, and a predicted value calculation unit 53. The gain updating unit 51 updates an innovation gain of a time-varying Kalman filter. The estimate updating unit 52 updates a state variable including an estimate value of the velocity of the head 1 (hereinafter referred to as a velocity estimate value). The predicted value calculation unit 53 calculates a predicted value of the velocity estimate value of the head 1 for the succeeding sampling time immediately after each sampling time.

The back electromotive force across the coil is proportional to the velocity of the head 1, thereby performing the velocity control by using the back electromotive force during the unload operation of the head 1.

It is required for the head 1 to surely run on the ramp mechanism 6 in the velocity control. When the head 1 starts to run on the ramp mechanism 6, large external force acts on the head 1. The large external force greatly decreases the velocity of the head 1. Accordingly, the large external force possibly causes the head 1 to damage the surface of the magnetic disk 5 or to fail to run on the ramp mechanism 6. In order to heighten the control bandwidth in the velocity control, a control system is configured for a high gain.

However, the above-described back electromotive force includes noise. Accordingly, the control system is configured for a high gain so that the head 1 surely runs on the ramp mechanism 6. Such a control system also amplifies the noise to further cause audible noise.

In the embodiment, the velocity estimation unit 50 uses the time-varying Kalman filter to estimate the velocity of the head 1, thereby removing an influence of the noise included in the back electromotive force V_{bemf}. The Kalman filter is also made to be time varying so that a gain of the control system is suitable.

Specifically, an innovation gain M of the time-varying Kalman filter is set suitably, thereby estimating the state variable to minimize an error of mean square of the signal including noise. The back electromotive force V_{bemf} is used as an observed value.

When the control cycle is expressed by a sampling time k (=0, 1, 2, . . . ) below, an innovation gain Mₖ of the time-varying Kalman filter in the control cycle k is expressed by the following equation:

Mₖ= P̅ₖC^{T}(C P̅ₖC^{T}+Rₖ)⁻¹ [Equation 3]

Pₖ is an error of the state variable. C is a coefficient matrix which relates the state of the system in the control cycle k to an observed value yₖ in the control cycle k.

A state variable xₖ can be estimated by the following equation using the innovation gain Mₖ and the observed value yₖ:

xₖ= x̅ₖ+Mₖ(yₖ−C x̅ₖ). [Equation 4]

In the embodiment, the back electromotive force V_{bemf} can be used as the observed value yₖ. A vector including both the velocity estimate value and the disturbance estimate value can be used as a state variable xₖ.

An error Pₖ of the state variable xₖ can be updated by the following equation using the innovation gain Mₖ:

Pₖ=(I−MₖC) P̅ₖ. [Equation 5]

The state variable in the control cycle k+1, i.e., the succeeding sampling time immediately after each sampling time can be expressed by the following equation using the estimate value of the state variable obtained by the above-described (Equation 4):

x̅ₖ₊₁=Axₖ+Bᵢ. [Equation 6]

uₖ is an input to a model of the VCM 4 in the control cycle k. A is a coefficient matrix to relate the state of the system in the control cycle k to the state of the system in the control cycle k+1. B is a coefficient matrix to relate the input uₖ in the control cycle k to the state of the system in the control cycle k+1.

An error Pₖ₊₁ of the state variable in the control cycle k+1, i.e., the succeeding sampling time immediately after each sampling time can be estimated by the following equation using the error Pₖ of the state variable obtained by the above-described (Equation 5):

P̅ₖ₊₁=APₖA^{T}+Q [Equation 7]

Q is a process noise and treated as a time-invariant parameter in the embodiment.

Accordingly, the above-described equations including (Equation 3) to (Equation 6) are calculated repeatedly, thereby enabling it to estimate the state variable given by (Equation 4) for each control cycle.

As the above-described coefficient matrixes A, B, and C, the same matrices as the respective coefficient matrices of an equation of state are used, for example. Prior inspection or the like provides the equation of state as a model expressing the characteristics of the VCM 4.

A gain updating unit 51 updates the innovation gain Mₖ of the time-varying Kalman filter for each control cycle. The gain updating unit 51 obtains the previously stored coefficient matrix C from the memory 9. The gain updating unit 51 updates the innovation gain Mₖ in accordance with the (Equation 3) using the coefficient matrix C, the parameter Rₖ, and a predicted value of a covariance matrix of an error. The parameter Rₖ is calculated by the parameter calculation unit 41. The predicted value of the covariance matrix of the error is calculated by a predicted value calculation unit 53 described later in the preceding sampling time immediately after each sampling time.

An estimate updating unit 52 calculates the state variable xₖ for each control cycle. The estimate updating unit 52 obtains the previously stored coefficient matrix C from the memory 9. The estimate updating unit 52 obtains the innovation gain Mₖ updated by the gain updating unit 51, the back electromotive force V_{bemf} calculated by the back electromotive force calculation unit 30, and a predicted value of the state variable. The predicted value of the state variable is calculated by the predicted value calculation unit 53 described later in the preceding sampling time immediately before each sampling time. The estimate updating unit 52 calculates the state variable xₖ in accordance with (Equation 4).

The estimate updating unit 52 uses the coefficient matrix C, the innovation gain Mₖ, and a predicted value of the covariance matrix of the error to calculate the covariance matrix Pₖ of the error for each control cycle in accordance with (Equation 5). The predicted value of the covariance matrix of the error is calculated by the predicted value calculation unit 53 described later in the preceding sampling time immediately before each sampling time.

The predicted value calculation unit 53 obtains each of the previously stored coefficient matrices A and B from the memory 9. The predicted value calculation unit 53 uses the state variable xₖ in the control cycle k and the control instruction uₖ in the control cycle k to calculate the predicted value of the state variable for the succeeding sampling time immediately after each sampling time in accordance with (Equation 6). The state variable xₖ in the control cycle k is updated by the estimate updating unit 52.

The predicted value calculation unit 53 obtains the coefficient matrix A and the previously stored process noise Q from the memory 9. The predicted value calculation unit 53 also obtains the covariance matrix Pₖ of the error in the control cycle k which is updated by the estimate updating unit 52. The predicted value calculation unit 53 calculates the predicted value of the covariance matrix Pₖ of the error for the succeeding sampling time immediately after each sampling time in accordance with (Equation 7).

### Velocity Control Unit

As shown in FIG. 3, a velocity control unit 60 has a difference-calculation unit 61, a control-instruction calculation unit 62, a disturbance-suppressing signal calculation unit 63, and a drive-instruction calculation unit 64. The unit 61 calculates a difference of the target velocity from the velocity estimate value. The unit 62 calculates the control instruction uₖ. The unit 63 calculates a disturbance suppressing signal. The unit 64 calculates the drive instruction V_{vcm} for the VCM drive circuit 7.

The difference-calculation unit 61 obtains the target velocity generated by the generation unit 20. The difference calculation unit 61 also obtains the state variable value xₖ to separate a component xᵥₖ of the velocity estimate value from the state variable xₖ. The state variable value xₖ is calculated by the estimate updating unit 52 for each control cycle. Multiplying the state variable xₖ by a matrix C1=[1 0] provides the component xᵥₖ, for example.

The difference calculation unit 61 subtracts the velocity estimate value xᵥₖ from the target velocity to calculate the velocity difference.

The control-instruction calculation unit 62 calculates a value as the control instruction uₖ. Multiplying the velocity difference by a gain K provides the value. The memory 9 stores the gain K previously. The difference calculation unit 61 calculates the velocity difference. The gain K can be previously obtained using a method of the background art from a parameter. The parameter is to determine the control characteristics such as a quick response or stability to be required at the time of the velocity control of the head 1, for example.

The disturbance-suppressing signal calculation unit 63 obtains the state variable xₖ calculated by the estimate updating unit 52 for each control cycle, separates a component x_{dk} of a disturbance estimate value from the state variable xₖ. The disturbance-suppressing signal calculation unit 63 multiplies the component x_{dk} by a minus to calculate a disturbance suppressing signal. The disturbance suppressing signal is to cancel out the disturbance which is estimated as the disturbance estimate value. Multiplying the state variable xₖ by a matrix C2=[0 −1] provides the disturbance suppressing signal.

When giving the control instruction uₖ to the VCM drive circuit 7, the drive-instruction calculation unit 64 calculates the drive instruction V_{vcm} which is actually to be given to the VCM drive circuit 7. The control instruction uₖ coincides with the drive instruction V_{vcm} in an ideal state. In fact, an amount of compensation due to external force is added to the drive instruction V_{vcm} as the disturbance suppressing signal in order to cancel out the influence of noise due to an external disturbance. The external force is to be experienced by the head 1 when the head 1 runs on the ramp mechanism 6.

The drive-instruction calculation unit 64 obtains the control instruction uₖ calculated by the control-instruction calculation unit 62 and a disturbance suppressing signal calculated by the disturbance-suppressing signal calculation unit 63. The control instruction uₖ and the disturbance suppressing signal are added to calculate the drive instruction V_{vcm}.

The velocity control unit 60 gives the drive instruction V_{vcm} calculated by the drive-instruction calculation unit 64 to the VCM drive circuit 7 for each control cycle and makes the velocity follow the target velocity to move the head 1.

In the embodiment, the time-varying Kalman filter eliminates the influence of noise when the velocity estimation unit 50 calculates the velocity estimate value of the head 1. The velocity control unit 60 uses the above-described velocity estimate value to calculate the control instruction, thereby enabling it to reduce audible noise during the unload operation. Hence, the embodiment can improve silence of the magnetic disk device during the unload operation.

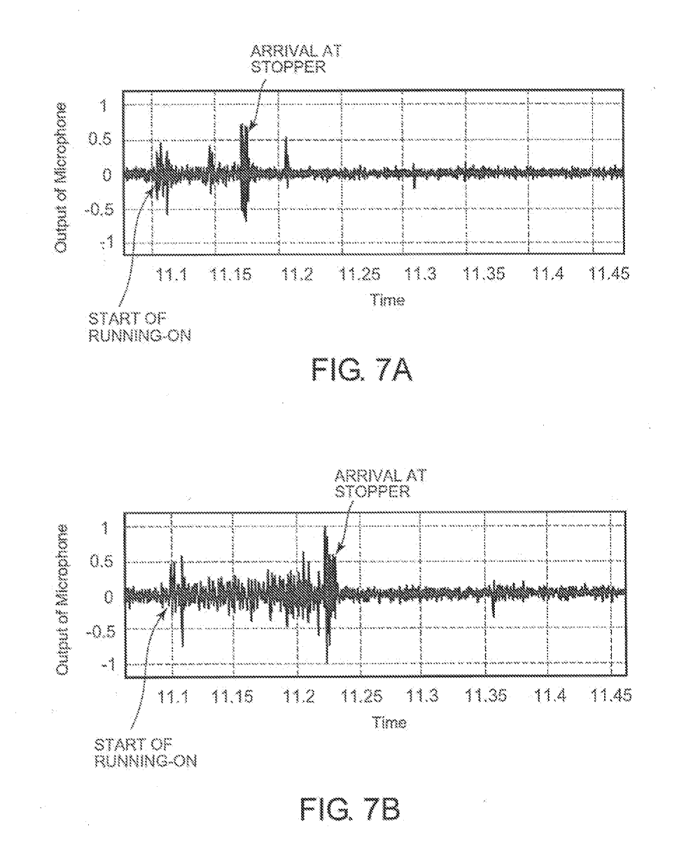

FIGS. 7A to 7B are graphs showing time histories of the output of microphone when audible noise was measured during the unload operation. FIG. 7A shows a result when the MPU 10 of the embodiment was used. FIG. 7B shows another result when an MPU of the background art was used.

The MPU 10 of the embodiment reduces audible noise more greatly than the MPU of the background art between the time of running on the ramp mechanism and the time of arriving at the stopper.

### Modification

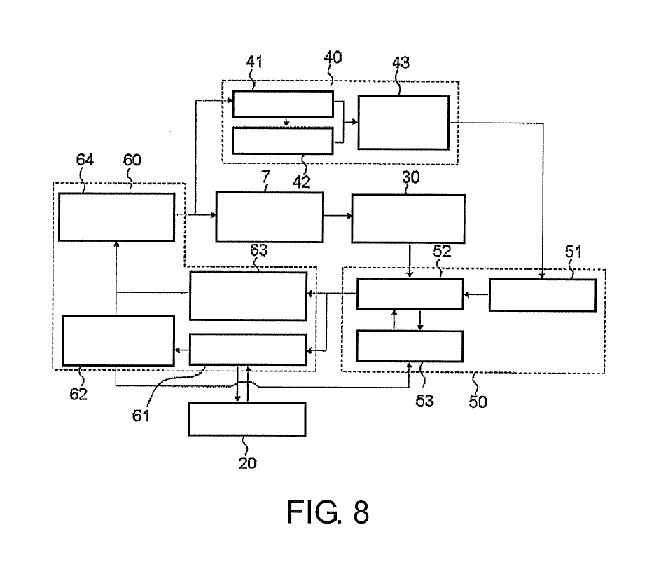

FIG. 8 is a block diagram for describing operation of the MPU 10 in accordance with a modification.

In the modification, the generation unit 20 uses the velocity estimate value xᵥₖ to generate a position target value of the head 1. The velocity estimate value xᵥₖ is calculated by the difference calculation unit 61 of the velocity control unit 60.

The generation unit 20 will be described in detail below. The same reference numerals will be used to denote the same or like portions throughout the figures below. Therefore, the same explanation will not be repeated.

The generation unit 20 generates the position target value of the head 1 for each control cycle. The memory 9 can store the position target value of the head 1 previously.

The generation unit 20 obtains the velocity estimate value xᵥₖ calculated by the difference calculation unit 61 and integrates the velocity estimate value xᵥₖ to calculate a position estimate value xᵣₖ as an estimate value of the position of the head 1 in each control cycle.

The generation unit 20 subtracts the position estimate value xᵣₖ from the above-described position target value to calculate a position difference.

The generation unit 30 multiplies the above-described position difference by a constant a, for example, to calculate the target velocity. The target velocity is inputted to the velocity control unit 60.

As a result, the start timing of running on the ramp mechanism 6 and the timing of colliding with the stopper can be reflected in more detail for the velocity control of the head 1, thereby enabling rapid unload operation.

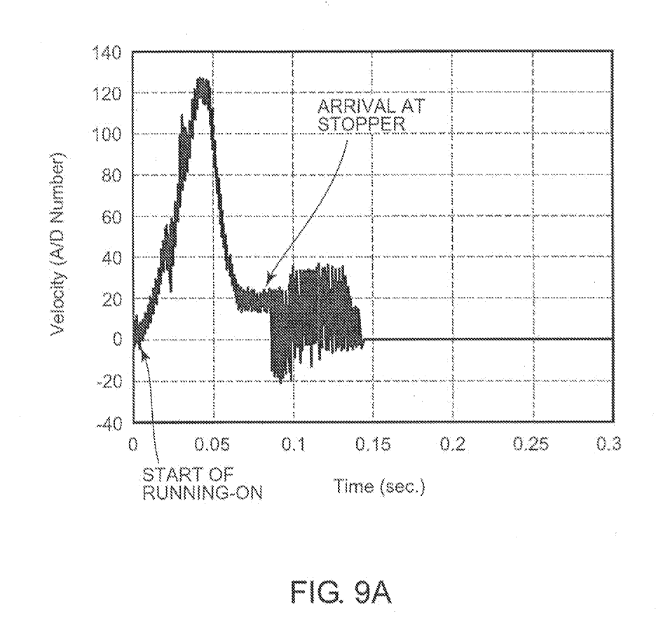

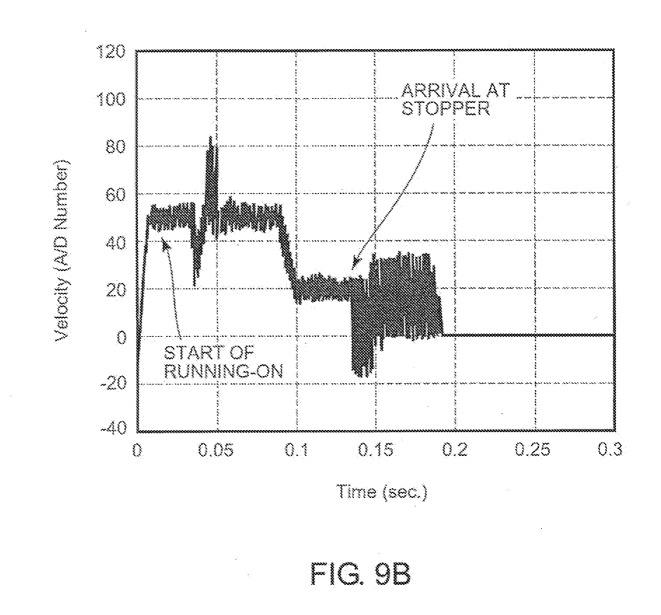

FIGS. 9A to 9B are time histories of the velocity of the head 1 during the unload operation. FIG. 9A shows a result obtained for the MPU 10 of the modification. FIG. 9B shows a result obtained for the MPU of the background art.

The MPU of the background art hides the right timing of running on the ramp mechanism from the view of FIG. 9B. Therefore, the stable unload operation requires a constant velocity of the head 1 during the time interval R-S in FIG. 9B. In contrast, the. MPU 10 of the modification enables the velocity control to take the position of the head 1 into consideration. As a result, it is possible to acquire the right timing of running on the ramp mechanism, thereby enabling it to make the time interval for the constant velocity of the head 1 shorter than the time interval R-S shown in FIG. 9B.

As can be seen in FIGS. 9A to 9B, the MPU 10 of the modification can make the time interval required for the unload operation shorter than the MPU 10 of the background art.

At least one of the above-described embodiments enables it to enhance silence of the magnetic disk device during the unload operation.

While certain embodiments have been described, those embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device, comprising:
a head to write in and read out information onto and from an information storage medium;
a coil motor having a coil with terminals at both ends, the coil motor moving the head;
a drive circuit to drive the coil motor;
a detector to detect an inter-terminal voltage across the coil;
a first calculation unit to calculate a back electromotive force across the coil by the use of the inter-terminal voltage;
a generation unit to generate a target velocity as a reference value of a moving velocity of the head;
a first estimation unit to estimate a first velocity of the head and an error of the first velocity by the use of the back electromotive force, the first estimation unit estimating a second velocity to decrease the error; and
a control unit to calculate a control instruction to bring the second velocity close to the target velocity.

2. The device according to claim 1, further comprising:
a second estimation unit to estimate disturbance applied to the head;
a detector to detect arrival of the head at a ramp mechanism during unload operation of the head by using the disturbance;
a second calculation unit, using a detection result of the detector, to calculate a parameter for adjusting the disturbance;
a first updating unit to update a gain for a reduction in the error by using the parameter;
a third calculation unit to calculate a predicted value of the first velocity by using the control instruction; and
a second updating unit to update an estimate value of the second velocity by using the predicted value and the parameter.

3. The device according to claim 2, further comprising:
a fourth calculation unit to calculate a signal for canceling out the disturbance applied to the head; and
a fifth calculation unit to calculate a drive instruction for the drive circuit by adding the control instruction and the signal.

4. The device according to claim 1, further comprising:
a sixth calculation unit to calculate a position of the head by using the moving velocity of the head, the generation unit using the position to generate the target velocity.

5. The device according to claim 3, further comprising:
a sixth calculation unit to calculate a position of the head by using the moving velocity of the head, the generation unit using the position to generate the target velocity.

6. A controlling method of a head included in a magnetic disk device, the device, comprising:
a head to write in and read out information onto and from an information storage medium;
a coil motor having a coil with terminals at both ends, the coil motor moving the head;
a drive circuit to drive the coil motor;
a detector to detect an inter-terminal voltage across the coil;
a first calculation unit to calculate a back electromotive force across the coil by the use of the inter-terminal voltage;
a generation unit to generate a target velocity as a reference value of a moving velocity of the head;
a first estimation unit to estimate a first velocity of the head and an error of the first velocity by the use of the back electromotive force, the first estimation unit estimating a second velocity for decreasing the error; and
a control unit to calculate a control instruction to bring the second velocity close to the target velocity,
the method comprising:
detecting the inter-terminal voltage across the coil;
calculating the back electromotive force across the coil, the first calculation unit using the inter-terminal voltage to calculate the back electromotive force across the coil;
generating the target velocity, the generation unit generating the target velocity, the target velocity serving as the reference value of the moving velocity of the head;
estimating the first velocity and the error, the first estimation unit using the back electromotive force to estimate the first velocity and the error;
estimating the second velocity, the first estimation unit estimating the second velocity to reduce the error; and
calculating the control instruction for bringing the second velocity close to the target velocity, the control unit calculating the control instruction.
